(19) United States
(12) Patent Application Publication
(10) Pub. No.: US 2026/0241668 A1
(43) Pub. Date: Aug. 20, 2026

(54) ALUMINUM-PLATED STAINLESS STEEL SHEET

(71) Applicant: NIPPON STEEL CORPORATION, Tokyo (JP)

(72) Inventors: Satoshi SAMPEI, Tokyo (JP); Shinichi TERAOKA, Tokyo (JP); Chikara ITO, Tokyo (JP); Akinori KAWANO, Tokyo (JP); Tooru MATSUHASHI, Tokyo (JP); Manabu OKU, Tokyo (JP)

(73) Assignee: NIPPON STEEL CORPORATION, Tokyo (JP)

(21) Appl. No.: 19/152,776

(22) PCT Filed: Jan. 19, 2024
(86) PCT No.: PCT/JP2024/001365

§ 371 Date: Jul. 31, 2025

(30) Foreign Application Priority Data
Jan. 31, 2023 (JP) 2023-012666

(51) Int. Cl. B32B 15/01; C22C 21/02; C22C 38/00; C22C 38/02; C22C 38/04; C22C 38/06; C22C 38/22; C22C 38/24; C22C 38/26; C22C 38/28; C22C 38/30; C22C 38/32; C22C 38/42; C22C 38/44; C22C 38/50; C22C 38/60

(52) U.S. Cl. CPC B32B 15/012; C22C 21/02; C22C 38/001; C22C 38/002; C22C 38/004; C22C 38/005; C22C 38/008; C22C 38/02; C22C 38/04; C22C 38/06; C22C 38/22; C22C 38/24; C22C 38/26; C22C 38/28; C22C 38/30; C22C 38/32; C22C 38/42; C22C 38/44; C22C 38/50; C22C 38/60

(57) ABSTRACT

An aluminum-plated stainless steel sheet: includes a stainless steel sheet, an aluminum-plating layer, and an alloy phase between the stainless steel sheet and the aluminum-plating layer; and contains predetermined components. The aluminum-plating layer contains 1 to 10% of Fe, 3 to 18% of Si, 0.1 to 1% of Cr, and a balance of Al, and contains a eutectic Si and an intermetallic compound phase consisting of Al—Si—Fe. An area ratio of the eutectic Si is 30% or less in a cross section of the aluminum-plating layer in a sheet thickness direction excluding a 1-μm-topmost layer, an area ratio of the intermetallic compound phase consisting of Al—Si—Fe is 5% or less in a cross section of the aluminum-plating layer, a thickness of the alloy phase is 15 μm or less, and a non-plated area ratio is 1.0% or less.

### TECHNICAL FIELD

The present invention relates to an aluminum-plated stainless steel sheet having excellent electrical conductivity, which is mainly suitable for use in electrical contact materials, electrical appliances, and the like.

### BACKGROUND ART

A stainless steel sheet containing Cr has excellent oxidation resistance and corrosion resistance, and is used for applications such as automobile exhaust system components, and roofing and building materials. However, the stainless steel sheet has poor electrical conductivity (contact resistance) due to the presence of a passivation film containing Cr on a surface thereof. To address this issue, techniques of reducing contact resistance by performing a surface treatment on a stainless steel sheet are known (Patent Literatures 1 and 2).

Further, a technique for plating a stainless steel sheet with metal having high electrical conductivity is also disclosed (Patent Literature 3).

The technique described in Patent Literature 1, which improves electrical conductivity of a stainless steel sheet by a surface treatment, is effective in terms of electrical conductivity. However, since a modified film of the stainless steel sheet is hard, the modified film may crack when subjected to plastic deformation by pressing or the like, resulting in deterioration of electrical conductivity.

The technique described in Patent Literature 2, which disperses highly conductive precipitates, is effective for improving electrical conductivity, but is high in production cost and low in productivity.

The technique described in Patent Literature 3, which involves hot-dip plating with aluminum having high electrical conductivity, is effective for improving electrical conductivity. However, the electrical conductivity may be deteriorated due to the presence of non-plated portions where no plating is formed as well as defects such as peeling of a plating layer when subjected to plastic deformation by pressing or the like.

### CITATION LIST

### Patent Literature(s)

Patent Literature 1: JP 2022-029296 A
Patent Literature 2: JP 2020-147817 A
Patent Literature 3: JP H08-319543 A

### SUMMARY OF THE INVENTION

### Problem(s) to be Solved by the Invention

An aluminum-plated stainless steel sheet is a steel sheet including an aluminum-plating layer (hereinafter, also referred to as a plating layer) mainly formed of aluminum, and a phase (hereinafter referred to as an alloy phase) formed of an intermetallic compound that is a reactant of a plated steel sheet and aluminum. When the aluminum-plated stainless steel sheet is plastically deformed, the above alloy phase cannot follow deformation of the plating layer and the stainless steel sheet and thus is fragmented to form gaps therein, which deteriorates electrical conductivity.

Further, in an aluminum-plating treatment of a stainless steel sheet, a surface free of the plating layer and alloy phase, which is referred to as non-plating, may be sometimes formed. Such a non-plated portion also deteriorates electrical conductivity.

In view of the above-mentioned current problems, an object of the invention is to provide an aluminum-plated stainless steel sheet having excellent electrical conductivity.

### Means for Solving the Problem(s)

With regard to this object, the inventors have conducted extensive research and found out a technique in which electrical conductivity is improved by flowing an aluminum-plating layer having high electrical conductivity into gaps formed in a brittle alloy phase fragmented by plastic deformation in an aluminum-plated stainless steel sheet through pressing or the like, and making the aluminum-plating layer flowing thereinto adhere to a steel sheet base. The gist thereof is as follows.
[1] An aluminum-plated stainless steel sheet, including: a stainless steel sheet; an aluminum-plating layer on a surface of the stainless steel sheet; and an alloy phase between the stainless steel sheet and the aluminum-plating layer, in which
   the stainless steel sheet contains, by mass %, 0.02% or less of C, 0.02 to 0.50% of Si, 0.02 to 1.00% of Mn, 0.040% or less of P, 0.0002 to 0.0100% of S, 0.004 to 0.100% of Al, 10.0 to 25.0% of Cr, 0.02 to 0.40% of Ti, 0.05% or less of N, and a balance of Fe and an impurity element,
   the aluminum-plating layer contains, by mass %, 1 to 10% of Fe, 3 to 18% of Si, 0.01 to 0.05% of Cr, and a balance of Al,
   the aluminum-plating layer contains a eutectic Si and an intermetallic compound phase consisting of Al—Si—Fe,
   an area ratio of the eutectic Si is 30% or less in a cross section in a rolling direction and in a sheet thickness direction excluding a 1-μm-topmost layer of the aluminum-plating layer,
   an area ratio of the intermetallic compound phase consisting of Al—Si—Fe is 5% or less in a cross section in the rolling direction and in the sheet thickness direction of the aluminum-plating layer,
   a thickness of the alloy phase is 15 μm or less, and
   a non-plated area ratio is 1.0% or less.
[2] The aluminum-plated stainless steel sheet according to [1], in which in place of a part of the Fe, the stainless steel sheet further contains, by mass %, one or more of 0.02 to 0.40% of Ni, 0.02 to 1.40% of Mo, and 0.02 to 1.40% of Cu.
[3] The aluminum-plated stainless steel sheet according to [1] or [2], in which in place of a part of the Fe, the stainless steel sheet further contains, by mass %, one or more of 0.0001 to 0.0020% of B, 1.00% or less of V, 0.005 to 0.50% of Zr, 0.030% or less of Ga, 0.001 to 0.10% of REM, 0.10% or less of Ta, 0.005 to 0.50% of Sn, 1.00% or less of W, 1.00% or less of Co, and 0.005 to 0.50% of Sb.

According to the aspect of the invention, an aluminum-plated stainless steel sheet having electrical conductivity necessary for a contact material can be provided.

### BRIEF DESCRIPTION OF DRAWINGS

FIG. 1 illustrates the result of evaluating a cross section in a sheet thickness direction of an aluminum-plated stainless steel sheet using a backscattered electron image of an Electron Probe Micro Analyzer (EPMA).

### DESCRIPTION OF EMBODIMENT(S)

The invention will be described in detail below.

The inventors have investigated a composition of a plating layer, a relationship between a passivation film composition of a stainless steel sheet before plating and a non-plated area ratio, and the effect thereof on electrical conductivity, and have reached the idea of the invention. Specifically, the inventors have found out that controlling an area ratio of a eutectic Si in an aluminum-plating layer at 30% or less in a cross section in a sheet thickness direction excluding a 1-μm-topmost layer of the aluminum-plating layer is effective for promoting the flow of the aluminum-plating layer into gaps in an alloy phase fragmented due to plastic deformation. Further, they have found out that setting an Fe/Cr ratio of the passivation film present on the stainless steel sheet before plating at 3.0 or more improves wettability of the plating and reduces the non-plated area ratio, which is effective for improving electrical conductivity.

The chemical composition, plating layer composition and production method of the aluminum-plated stainless steel sheet with excellent electrical conductivity defined in the invention will be described below. The percentage (%) for the chemical composition refers to mass %. Hereinafter, “A % to B %” in a numerical range means A % or more and B % or less.

### Chemical Composition of Stainless Steel Sheet

### C: 0.02% or Less

C deteriorates formability and corrosion resistance of a steel sheet, so its content must be kept low. The upper limit of the C content is 0.02%. Since excessive reduction in the C content increases a refining cost, the lower limit is preferably 0.002%. The C content is preferably in a range from 0.003% to 0.013%, more preferably in a range from 0.004% to 0.012%, and most preferably in a range from 0.005% to 0.011%.

### Si: 0.02 to 0.50%

Si is useful as a deoxidizer, and is also an element effective for high-temperature strength and oxidation resistance. Since excessive reduction of an Si content increases a growth rate of the alloy phase, the lower limit is 0.02%. On the other hand, an excessive Si content increases the non-plated area ratio. The upper limit is thus 0.50%. The Si content is preferably in a range from 0.02% to 0.45%, more preferably in a range from 0.03% to 0.42%, and most preferably in a range from 0.04% to 0.35%.

### Mn: 0.02 to 1.00%

Mn is an element added as a deoxidizer. However, excessive addition of Mn deteriorates corrosion resistance and oxidation resistance and also increases the non-plated area ratio. The upper limit of an Mn content is thus 1.00%. When the Mn content is less than 0.02%, unevenness at an interface between a hot-rolled scale and a base increases, and the surface becomes rough, causing appearance defects after plating. The lower limit is thus 0.02%. The Mn content is preferably in a range from 0.02% to 0.90%, more preferably in a range from 0.03% to 0.80%, and most preferably in a range from 0.04% to 0.70%.

### P: 0.040% or Less

Since P is an element that impairs toughness of a base material and welded portions, the upper limit of a P content is 0.040%. However, when the P content in stainless steel is extremely reduced, a production cost increases. The lower limit of the P content is preferably 0.010%. The P content is preferably in a range from 0.012% to 0.038%, more preferably in a range from 0.014% to 0.035%, and most preferably in a range from 0.015% to 0.032%.

### S: 0.0002 to 0.0100%

Since S is a harmful element that adversely affects corrosion resistance and hot cracking of welded portions, the upper limit of an S content is 0.0100%. Since improvement in corrosion resistance due to reduction of the S content is saturated at the S content of 0.0002%, the lower limit is 0.0002%. The S content is preferably in a range from 0.0002% to 0.0050%, more preferably in a range from 0.0002% to 0.0025%, and most preferably in a range from 0.0002% to 0.0015%.

### Al: 0.004 to 0.100%

Al is added as a deoxidizing element, and also improves oxidation resistance. When an Al content is less than 0.004%, a production cost for deoxidation increases. The lower limit is thus 0.004%. On the other hand, excessive addition of Al increases the non-plated area ratio. The upper limit of the Al content is thus 0.100%. The Al content is preferably in a range from 0.006% to 0.090%, more preferably in a range from 0.008% to 0.085%, and most preferably in a range from 0.008% to 0.080%.

### Cr: 10.0 to 25.0%

Cr is an essential element for exhibiting basic corrosion resistance of a stainless steel sheet. When a Cr content is less than 10.0%, a stable passivation film is not formed. The lower limit is thus 10.0%. On the other hand, excessive addition of Cr increases the non-plated area ratio. The upper limit of the Cr content is thus 25.0%. The Cr content is preferably in a range from 10.4% to 24.4%, more preferably in a range from 10.6% to 23.5%, and most preferably in a range from 11.1% to 22.8%.

### Ti: 0.02 to 0.40%

Ti is an element bonded with C, N, and S to improve corrosion resistance, intergranular corrosion resistance, normal-temperature ductility, and deep drawability. When a Ti content is less than 0.02%, no improvement in the above properties is expected, so the lower limit is 0.02%. On the other hand, when the Ti content exceeds 0.40%, the non-plated area ratio increases. The upper limit of the Ti content is thus 0.40%. The Ti content is preferably in a range from 0.03% to 0.38%, more preferably in a range from 0.03% to 0.35%, and most preferably in a range from 0.03% to 0.33%.

### N: 0.050% or Less

Similar to C, N deteriorates formability and corrosion resistance, so an N content is 0.050% or less. Since excessive reduction of the N content increases a refining cost, the lower limit is preferably 0.002%. The N content is more preferably in in a range from 0.002% to 0.023%, still more preferably in a range from 0.002% to 0.022%, and most preferably in a range from 0.003% to 0.021%.

The balance of the above steel components is Fe and impurities. The impurities herein mean substances in raw materials such as ore and scrap as well as components mixed in the manufacturing process due to various factors when the steel sheet is industrially manufactured, the substances and the components being allowable within a range that does not adversely affect the invention.

In place of a part of the Fe, one or more of 0.02 to 0.40% of Ni, 0.02 to 1.40% of Mo, and 0.02 to 1.40% of Cu may be contained in order to ensure corrosion resistance of stainless steel.

### Ni: 0.02 to 0.40%

Ni is an element that improves corrosion resistance, and can be added as necessary. When an Ni content is less than 0.02%, no improvement in corrosion resistance is expected, so the lower limit is 0.02%. Since the Ni content exceeding 0.40% deteriorates not only oxidation resistance but also workability, the upper limit is 0.40%. The Ni content is preferably in a range from 0.02% to 0.38%, more preferably in a range from 0.03% to 0.35%, and most preferably in a range from 0.03% to 0.32%.

### Mo: 0.02 to 1.40%

Mo is an element that improves corrosion resistance. When an Mo content is less than 0.02%, no improvement in corrosion resistance is expected, so the lower limit is 0.02%. Excessive addition of Mo deteriorates workability and oxidation resistance and also leads to an alloy cost increase. The upper limit of the Mo content is thus 1.40%. In view of productivity, scale adhesion, and alloy cost, the Mo content is desirably in a range from 0.30% to 1.20%. The Mo content is preferably in a range from 0.02% to 1.30%, more preferably in a range from 0.02% to 1.20%, and most preferably in a range from 0.02% to 1.10%.

### Cu: 0.02 to 1.40%

Cu is an element that improves corrosion resistance and high-temperature strength, and can be added as necessary. When a Cu content is less than 0.02%, no improvement in corrosion resistance is expected, so the lower limit is 0.02%. Since the Cu content exceeding 1.40% significantly deteriorates ductility, the upper limit is 1.40%. In view of productivity and oxidation resistance, the Cu content is desirably in a range from 0.30% to 1.20%. The Cu content is preferably in a range from 0.02% to 1.30%, more preferably in a range from 0.02% to 1.20%, and most preferably in a range from 0.02% to 1.10%.

Further, in order to ensure corrosion resistance and productivity of stainless steel, one or more of 0.0001 to 0.0020% of B, 1.00% or less of V, 0.005 to 0.50% of Zr, 0.030% or less of Ga, 0.01% or less of REM, 0.10% or less of Ta, 0.005 to 0.50% of Sn, 1.00% or less of W, 1.00% or less of Co, and 0.005 to 0.50% of Sb may be contained, in place of a part of the Fe.

### B: 0.0001 to 0.0020%

B, which is an element that enhances the strength of grain boundaries, contributes to improving workability. When B is contained, a B content is preferably 0.0001% or more in order to achieve this effect. However, excessive addition of B reduces workability because of ductility reduction. Accordingly, the upper limit of the B content is preferably 0.0020%. The B content is preferably in a range from 0.0003% to 0.0018%, more preferably in a range from 0.0005% to 0.0015%, and most preferably in a range from 0.0005% to 0.0013%.

V: 1.00% or less

V, which has an effect of improving corrosion resistance, may be contained as necessary. However, an excessive V content reduces toughness. Further, coarse carbonitrides reduce toughness. Accordingly, the V content is preferably 1.00% or less. The V content is more preferably 0.9% or less, still more preferably 0.8% or less, and most preferably 0.7% or less.

### Zr: 0.005 to 0.50%

Zr can be added as necessary to improve corrosion resistance, and exhibits this effect at a content of 0.005% or more. Zr is an important element for reducing a corrosion rate, but excessive addition of Zr deteriorates productivity and increases costs. The upper limit is thus preferably 0.50%. The Zr content is more preferably in a range from 0.008% to 0.45%, still more preferably in a range from 0.020% to 0.40%, and most preferably in a range from 0.050% to 0.35%.

### Ga: 0.030% or Less

Ga, which has an effect of improving corrosion resistance, may be contained as necessary. However, an excessive Ga content reduces hot workability, so the Ga content is preferably 0.030% or less. The Ga content is more preferably 0.020% or less, still more preferably 0.015% or less, and most preferably 0.012% or less.

### REM: 0.001 to 0.10%

REM, which is an element that improves hot workability and steel cleanliness and is effective for improving corrosion resistance of the invention, may be added as necessary. When REM is added, an REM content is preferably 0.001% or more at which the above effect is exhibited. However, excessive addition of REM leads to increasing alloy cost and decreasing productivity. The upper limit is thus preferably 0.10%. The REM content is more preferably in a range from 0.001% to 0.08%. The REM content is still more preferably in a range from 0.001% to 0.06%, most preferably in a range from 0.001% to 0.05%. REM is an element belonging to atomic numbers of 57 to 71, examples of which include La, Ce, and Nd.

### Ta: 0.10% or Less

Ta, which is an element effective for improving corrosion resistance, may be contained at a content of 0.01% or more as necessary. Since an excessive Ta content decreases toughness, the Ta content is preferably 0.10% or less. The Ta content is preferably in a range from 0.04% to 0.10%, more preferably in a range from 0.06% to 0.10%, and most preferably in a range from 0.08% to 0.10%.

### Sn: 0.005 to 0.50%

Addition of Sn has an effect of further enhancing high corrosion resistance of stainless steel. In order to exhibit this effect, the lower limit of an Sn content is preferably 0.005%. However, since excessive addition of Sn leads to reduction in workability, the upper limit of the Sn content is preferably 0.50%. The Sn content is more preferably in a range from 0.01% to 0.4%, still more preferably in a range from 0.03% to 0.35%, and most preferably in a range from 0.03% to 0.30%.

### W: 1.00% or Less

W, which has an effect of improving corrosion resistance, may be contained as necessary. However, an excessive W content reduces toughness due to coarse carbonitrides or the like. The W content is preferably 1.00% or less. The W content is more preferably 0.90% or less, still more preferably 0.80% or less, and most preferably 0.70% or less.

### Co: 1.00% or Less

Co, which has an effect of improving corrosion resistance of a steel product, may be contained as necessary. However, since an excessive Co content reduces toughness, the Co content is preferably 1.00% or less. The Co content is more preferably 0.90% or less, still more preferably 0.80% or less, and most preferably 0.70% or less.

### Sb: 0.005 to 0.50%

Sb can be added as necessary to improve corrosion resistance, and exhibits this effect at a content of 0.005% or more. Sb is an important element for reducing a corrosion rate, but excessive addition of Sb deteriorates productivity and increases costs. The upper limit of an Sb content is thus preferably 0.50%. The Sb content is more preferably in a range from 0.005% to 0.40%, still more preferably in a range from 0.005% to 0.35%, and most preferably in a range from 0.005% to 0.30%.

### Aluminum-Plating Layer

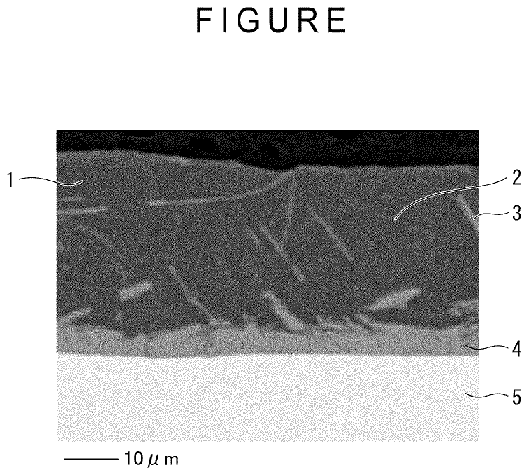

FIG. 1 shows a photograph of the cross section in the sheet thickness direction of the aluminum-plated stainless steel sheet evaluated using a backscattered electron image of the EPMA. As shown in FIG. 1, the aluminum-plated stainless steel sheet includes an alloy phase 4 located between a stainless steel sheet 5 and an aluminum-plating layer 1, and a eutectic Si 2 and an intermetallic compound phase 3 consisting of Al—Si—Fe that are in the aluminum-plating layer 1.

In the cross section in the sheet thickness direction of the aluminum-plated stainless steel sheet, a boundary between the aluminum-plating layer 1 and the alloy phase 4 can be identified as a boundary where an Al concentration is 50% or more and an Fe concentration is less than 10% in EPMA map analysis, and a boundary between the alloy phase 4 and the stainless steel sheet 5 can be identified as a boundary where a Cr concentration exceeds 10% in the EPMA map analysis.

In order to investigate a relationship between the composition and the production process of the above aluminum-plating layer, the experiment as below was carried out.

### Experiment

An aluminum-plated stainless steel sheet is made into a product through steps of casting, hot rolling, pickling, cold rolling, annealing, pickling and plating. In addition to the steel components, the inventors conducted a detailed study on the relationship between contact resistance after processing, and an electrolytic degreasing condition before plating and a cooling rate condition in a temperature range from 640 to 690 degrees C. of a steel sheet pulled up from a plating bath in the plating step.

The contact resistance can be measured by a four-terminal method, using a CRS-1 model manufactured by Yamazaki Seiki Kenkyusho, according to the measuring method of surface electrical contact resistance, JCBA T323:2011, published by the Japan Copper and Brass Association. For example, the measurement is performed with a maximum load of 1 N, a sliding distance of 1 mm, and an applied current of 10 mA.

When preparing a test piece for the contact resistance measurement, a cold-rolled sheet, which was annealed and pickled, having a composition of 17.2% of Cr-0.21% of Ti—0.08% of Si—0.12% of Mn—0.08% of Al—0.004% of C—0.011% of N was subjected to an anodic electrolysis treatment in an alkaline aqueous solution, and then to a heat treatment. The heat treatment was performed in an atmosphere containing a mixture of nitrogen and hydrogen at a dew point of −30 degrees C., at an annealing temperature of 690 degrees C., for a soaking time of 60 seconds. Subsequently, the steel sheet was immersed in a molten aluminum plating bath containing 6 to 15% of Si and Al as the balance and kept at a temperature of 680 degrees C., and was cooled when pulled up from the plating bath to form a plating layer. The cooling rate in a temperature range from 640 to 690 degrees C. was controlled at a range from −3 to 30 degrees C./s by changing a cooling gas pressure. The composition in a passivation film after the anodic electrolysis treatment was analyzed. In addition, the composition of a plating layer cross section was analyzed after plating.

In the invention, as the composition of the passivation film present on the surface of the steel sheet after electrolytic degreasing performed before plating, the maximum value in terms of the Fe/Cr concentration ratio was used. The Fe/Cr concentration ratio was constituted by the concentrations (mass %) of the respective elements within 10 nm from the surface that were obtained by measuring the concentration distribution of the respective elements from the surface to a depth of 10 nm. The concentration distribution of the elements was measured using a glow discharge emission spectrophotometer (GDA750, manufactured by Rigaku Corporation).

Aluminum-plating Layer: by mass %, Fe: 1 to 10%, Si: 3 to 18%, Cr: 0.01 to 0.05%, and Balance: Al

A composition of the aluminum-plating layer 1 in the cross section of the aluminum-plated stainless steel sheet was obtained from the EPMA concentration map analysis. The analysis of the cross section was performed in a region of 5 μm in a plating thickness direction and 100 μm in a cross section longitudinal direction.

The aluminum-plating layer 1 of the invention contains Si in a range from 3% to 18%, as a component other than Al. By containing Si in the aluminum plating bath, a thickness of the alloy phase 4 can be adjusted as described below. When the thickness of the alloy phase 4 is suitably adjusted, the Si content in the formed aluminum-plating layer 1 is in a range from 3 to 18%. The Si content is preferably in a range from 4 to 17%, more preferably in a range from 5 to 16%, and most preferably in a range from 6 to 15%.

When the aluminum-plating layer is formed by hot-dip plating, Fe eluted from equipment or a steel strip in a bath may be contained in a range from 1 to 10% in the aluminum-plating layer. Limiting the Fe content to less than 1% is not preferable because costs increase significantly. The Fe content exceeding 10% reduces ductility of the aluminum-plating layer, making it difficult for plating to flow during processing. As a result, voids are generated at an interface between the aluminum plating and a steel sheet base, which increases contact resistance. The upper limit of the Fe content is thus 10%. The Fe content is preferably in a range from 1 to 9%, more preferably in a range from 1 to 8%, and most preferably in a range from 1 to 5%.

When the aluminum-plating layer is formed by hot-dip plating, Cr eluted from the steel strip in the bath may be contained in a range from 0.01 to 0.05% in the aluminum-plating layer. The Cr content less than 0.01% is not preferable because costs increase significantly. The Cr content exceeding 0.05% reduces ductility of the aluminum-plating layer, making it difficult for plating to flow during processing. As a result, voids are generated at the interface between the aluminum plating and the steel sheet base, which increases contact resistance. The upper limit of the Cr content is thus 0.05%. The Cr content is preferably in a range from 0.01 to 0.04%, most preferably in a range from 0.01 to 0.03%.

The Al—Si based plating bath can also be added, as the other elements, with one or more of Mg, Ca, Sr, Ni, Cu, Ti, Ce, La, Mn, Co, Mo, An, and Sn, each in a range from 0.001% to 1%. Mg, Ca, Mn, Ni, Cu, Co, Mo, Zn, and Sn contribute to improving corrosion resistance. Sr, Ti, Ce, and La change a dispersion state of Si in Al—Si, thereby contributing to improving corrosion resistance. The above effects are exhibited at the addition of 0.001% or more. However, the addition of 1.0% or more is not preferable because it increases an amount of intermetallic compounds called dross floating in the bath and promotes, for example, an increase in the melting point. The elements are each added preferably in a range from 0.001 to 0.9%, more preferably in a range from 0.001 to 0.8%, and most preferably in a range from 0.001 to 0.7%.

### Aluminum-plating Layer Containing Eutectic Si and Intermetallic Compound Phase Consisting of Al—Si—Fe

The aluminum-plating layer 1 of the stainless steel sheet plated with the above aluminum plating bath composition contains the eutectic Si 2 and the intermetallic compound phase 3 consisting of Al—Si—Fe, as illustrated in FIG. 1.

In the cross section of the aluminum-plating layer 1 in a rolling direction and the sheet thickness direction, a region of the eutectic Si 2 and a region of the intermetallic compound phase consisting of Al—Si—Fe (hereinafter, simply referred to as the “intermetallic compound phase 3”) were obtained from the EPMA concentration map analysis. Here, the cross section in the rolling direction and the sheet thickness direction means a cross section parallel to both of the rolling direction and the sheet thickness direction.

From the obtained concentration map, a region (A) where Si is 10% or more is selected, and in order to eliminate influence of the alloy phase where Si is concentrated, a region (B) where Fe is 1% or more is selected within the region (A). A region obtained by excluding the region (B) from the region (A) is a region (C) of the intermetallic compound phase 3. An area ratio of the intermetallic compound phase 3 can be calculated by dividing an area of the region (C) by a plating layer area.

From the obtained concentration map, a region (X) where Si is 10% or more, excluding the 1-μm-plating-topmost layer, is selected, and in order to eliminate the influence of the alloy phase where Si is concentrated, a region (Y) where Fe is 1% or more and Cr is 0.5% or more is selected within the region (X). A region obtained by excluding the region (Y) from the region (X) is a region (Z) of the eutectic Si 2. A eutectic Si area ratio can be calculated by dividing an area of the region (Z) by the plating layer area.

During a solidification process of the aluminum plating, first, the intermetallic compound consisting of Al—Si—Fe, which has a high melting point, is crystallized into a form of plate, subsequently Al is crystallized into a form of dendrite, and then Si forms a eutectic with Al between the Al dendrites.

### Area Ratio of Intermetallic Compound Phase Consisting of Al—Si—Fe: 5% or Less

In the invention, the area ratio of the intermetallic compound phase 3 consisting of Al—Si—Fe is 5% or less in the cross section in the rolling direction and the sheet thickness direction. The intermetallic compound phase consisting of Al—Si—Fe included in the aluminum-plating layer has poor ductility and cracks during processing, thereby reducing ductility of the aluminum-plating layer, and making it difficult for the plating layer to flow during the processing. As a result, voids are generated at an interface between the plating layer and the steel sheet base, which increases contact resistance. The area ratio of the intermetallic compound phase 3 being 5% or less can prevent contact resistance from increasing.

### Preferred Component Composition of Intermetallic Compound Phase Consisting of Al—Si—Fe: Fe: 15 to 50%, Si: 1 to 18%, and Balance: Al

When the Fe content exceeds 50% or the Si content exceeds 18% in the intermetallic compound phase, workability tends to decrease. Thus, the preferred upper limits of the Fe content and the Si content are 50% and 18%, respectively. Further, when the Fe content is less than 15% or the Si content is less than 1% in the intermetallic compound phase, corrosion resistance of the aluminum plating tends to decrease. Thus, the preferred lower limits of the Fe content and the Si content are 15% and 1%, respectively.

Eutectic Si Area Ratio in Plating Layer Cross Section Excluding 1 μm-Plating-Topmost Layer: 30% or Less

As described above, electrical conductivity can be improved by flowing an aluminum-plating layer having high electrical conductivity into gaps formed in a brittle alloy phase fragmented by plastic deformation in an aluminum-plated stainless steel sheet through pressing or the like, and making the aluminum-plating layer flowing thereinto adhere to a steel sheet base. The inventors have found out that controlling the eutectic Si area ratio at 30% or less in the plating layer cross section of the aluminum-plating layer excluding the 1-μm-topmost layer is effective for promoting the flow of the aluminum-plating layer into gaps in the alloy phase fragmented due to plastic deformation, and that this improves the electrical conductivity of the aluminum-plated stainless steel sheet after the plastic deformation.

During a cooling process of the aluminum plating, the Al dendrites grow toward a plating surface layer, and Si forms a eutectic with Al between the Al dendrites. Therefore, the eutectic Si has a distribution concentrated in the plating surface layer. Since the eutectic Si hinders fluidity of the aluminum plating, the eutectic Si area ratio in the plating layer cross section is important. The eutectic Si within the 1-μm-surface layer, which does not affect the fluidity of the plating, is excluded.

When the eutectic Si area ratio exceeds 30% in the cross section in the rolling direction and in the sheet thickness direction excluding the 1-μm-topmost layer, the fluidity of the plating layer is hindered and gaps are formed between the fragmented alloy phases, which increase contact resistance. The eutectic Si area ratio is preferably 25% or less, more preferably 20% or less, and still more preferably 15% or less. The lower limit of the eutectic Si area ratio is desirably 0%, but the feasible lower limit is 3%.

### Alloy Phase

In the aluminum-plated stainless steel sheet, the alloy phase 4 is formed between the stainless steel sheet 5 and the aluminum-plating layer 1, as illustrated in FIG. 1. In general, the alloy phase 4 is less ductile than the aluminum-plating layer 1 and the material of the stainless steel sheet 5, and has a property of fracturing in a brittle manner to be fragmented during processing. When an aluminum-plated stainless steel sheet is processed utilizing this property, the alloy phase having high electrical resistance is fragmented by processing, and the aluminum plating is allowed to flow so as to fill in spaces between the alloy phase fragments, thereby partially forming a region free of alloy phase on a stainless steel sheet base. It is thus possible to obtain an aluminum-plated stainless steel sheet with reduced contact resistance.

The composition of the alloy phase is determined by the above aluminum-plating layer composition and Fe, Si, and Cr diffusing from the stainless steel sheet base. The composition of the alloy phase is 15 to 50% of Fe, 1 to 18% of Si, 0.01 to 0.05% of Cr, and the balance of Al. The composition of the alloy phase can be obtained from the EPMA concentration map analysis.

### Thickness of Alloy Phase: 15 μm or Less

The alloy phase is hard and thus may crack, for example, when subjected to shear deformation during processing, and the alloy phase with a thickness exceeding 15 μm hinders the flow of the aluminum plating and generates voids at the interface between the aluminum plating and the steel sheet base, thereby decreasing contact resistance. The upper limit of the thickness of the alloy phase is thus 15 μm. The thickness is preferably 10 μm or less, more preferably 8 μm or less, and still more preferably 5 μm or less. When the thickness of the alloy phase is less than 1 μm, the adhesion to the plating layer decreases and the plating layer peels off. The lower limit is thus preferably 1 μm or more.

### Non-Plated Area Ratio: 1.0% or Less

During the production, the aluminum-plated stainless steel sheet may have a surface where the steel sheet is exposed without plating being adhered thereon, which is referred to as non-plating. The non-plating occurs due to poor wettability between the plating bath and the passivation film on the stainless steel sheet. Especially, as a Cr/Fe composition ratio in the passivation film becomes higher, the wettability decreases accordingly, which easily causes the non-plating. When the non-plating occurs, the plating layer peels off starting from a non-plated portion during processing and pure stainless steel is exposed, which deteriorates electrical conductivity. The non-plated area ratio exceeding 1.0% promotes the peeling of the aluminum plating, resulting in deterioration of electrical conductivity. When the non-plated area ratio is 1.0% or less, peeling of the aluminum plating can be inhibited. The non-plated area ratio in the invention is thus 1.0% or less. The non-plated area ratio is preferably 0.5% or less, more preferably 0.1% or less, and most preferably 0.05% or less.

The non-plated area ratio is calculated from image analysis of a photograph of a steel sheet surface, which is taken in a state where the aluminum plating is peeled off from a surface of 100×100 mm of an aluminum-plated stainless steel sheet in a solution containing 20% of NaOH to expose the alloy phase. The alloy phase, which is blackened after the peeling of the aluminum plating, is distinguishable from the lustrous steel sheet base.

### Production Method

The production method of an aluminum-plated stainless steel sheet will be described below.

### Stainless Steel Sheet

The production method of the stainless steel sheet of the invention includes steps of steelmaking, hot rolling, pickling, cold rolling, annealing, and pickling.

In the steelmaking, preferably, a steel having a composition containing the above essential components and component(s) added as necessary is smelted in a converter and is then subjected to secondary refining. The molten steel obtained is formed into a slab according to a known casting process (continuous casting).

The slab is heated to a predetermined temperature and hot-rolled to have a predetermined thickness through continuous rolling. The hot-rolled steel sheet is pickled as necessary. In addition, hot-rolled sheet annealing after the hot rolling may be performed or may be omitted in consideration of productivity and material properties.

Regarding the cold rolling conditions, the cold rolling of the stainless steel sheet is typically performed by reverse rolling using a Sendzimir rolling mill with a roll diameter of about 50 to 100 mm, or performed by unidirectional rolling using a tandem rolling mill with a roll diameter of 400 mm or more. Either of the above cold rolling methods may be adopted in the invention.

The conditions for annealing and pickling the cold-rolled steel sheet after cold rolling are not particularly specified, but may be appropriately selected depending on the required material quality level.

Other steps of the production method are not particularly specified, and the hot rolling conditions, hot rolled sheet thickness, and the like may be appropriately selected. The product may be subjected to temper rolling and/or passed through a tension leveler after the cold rolling and annealing. Further, the sheet thickness of the product may be determined depending on a required thickness of the member.

### Plating Treatment

The above steel sheet, particularly the cold-rolled steel sheet, is annealed in an N₂—H₂ mixed gas atmosphere at a predetermined temperature and time, for example, at a temperature of 750 to 850 degrees C. for 10 seconds to 5 minutes, and then cooled in an inert atmosphere such as a nitrogen atmosphere to near a temperature of the plating bath. Subsequently, the steel sheet is immersed in an aluminum plating bath containing Si in a range from 3 to 15 mass % at a temperature from 600 to 750 degrees C. for 0.1 to 60 seconds, and then pulled up from the bath. N₂ gas or air is immediately sprayed onto the steel sheet by gas wiping to adjust an adhesion amount of aluminum plating within a predetermined range, e.g., within a range from 40 to 200 g/m² in total on both surfaces of the steel sheet. Finally, the steel sheet is cooled by spraying air or the like onto the steel sheet, and thereby an aluminum-plating layer is formed on one or both surfaces of the steel sheet.

When aluminum plating is applied to a stainless steel sheet, typically, the sheet is annealed in a reducing atmosphere before the immersion in the plating bath as described above. Since the Cr contained in stainless steel can be oxidized even in a reducing atmosphere, a Cr₂O₃ film is formed on the surface of the stainless steel sheet. The Cr₂O₃ film, which has poor wettability with the aluminum plating bath, repels the aluminum plating and causes non-plating. As a result of intensive investigation of how to avoid plating wettability reduction due to the Cr₂O₃ film, it has been discovered that an anodic electrolytic treatment of the stainless steel sheet in an electrolytic degreasing step before annealing in a reducing atmosphere is effective for improving plating wettability.

### Non-Plated Area Ratio

On the surface of the stainless steel sheet, an extremely thin oxide film having a few nanometers thick and mainly composed of Fe and Cr is formed, which is referred to as a passivation film. The anodic electrolysis treatment keeps the stainless steel sheet in a transpassive potential region of Cr, and Cr is selectively dissolved. This treatment concentrates Fe in the topmost layer of the passivation film. By performing annealing in a reducing atmosphere on the stainless steel sheet with the above surface state, the Fe oxide in the topmost layer is reduced to metal Fe, and the Cr₂O₃ film is formed directly below it, improving the wettability of the plating. Further, the Fe/Cr ratio in the passivation film being 3.0 or more as an Fe concentration index is preferred in order to keep the non-plated area ratio at 1.0% or less. Since the feasible Fe/Cr ratio in the electrolytic degreasing step is 10.0, the substantial upper limit is 10.0.

The Fe/Cr ratio in the passivation film can be 3.0 or more by performing anodic electrolysis at a current density of 0.1 to 2.0 A/cm² for an electrolysis time of 1 to 300 seconds in the electrolytic degreasing step using an alkaline solution. For example, a solution containing 10% of NaOH may be used as the alkaline solution.

When the current density exceeds 2.0 A/cm², the base dissolves excessively, causing noticeable unevenness on a surface of the base and impairing the appearance after plating. The upper limit is thus 2.0 A/cm². When the current density is less than 0.1 A/cm², the selective dissolution of Cr during electrolytic degreasing, i.e., the concentration of Fe is unlikely to occur, and the Fe/Cr ratio in the passivation film cannot be controlled at 3.0 or more. The lower limit is thus 0.1 A/cm².

When the electrolysis time exceeds 300 seconds, similarly, the base dissolves excessively, causing noticeable unevenness on the surface and impairing the appearance after plating. The upper limit is thus 300 seconds. When the electrolysis time is less than 1 second, a selective dissolution amount of Cr during electrolytic degreasing is small, i.e., an Fe concentration amount is insufficient, and the Fe/Cr ratio in the passivation film cannot be controlled at 3.0 or more. The lower limit is thus 1 second.

### Aluminum-Plating Layer

### Composition of Aluminum-Plating Layer

By adjusting the Si content in the plating bath, the thickness of the alloy phase between the stainless steel sheet and the aluminum-plating layer can be adjusted. By further performing fine adjustment of the Si content in the plating bath within the above adjustable range, the Si content in the aluminum-plating layer can be adjusted to a range from 3 to 18% in the components of the aluminum-plating layer.

As described above, when an aluminum-plating layer is formed on the surface of a stainless steel sheet by hot-dip plating, Fe is eluted from the equipment and steel strip in the bath. In addition, Cr is eluted from the steel strip in the bath. By adjusting the concentrations of the eluted Fe and Cr in the plating bath, the Fe content and the Cr content can be adjusted to a range from 1 to 10% and a range from 0.1 to 1.0%, respectively, in the components of the aluminum-plating layer.

### Area Ratio of Eutectic Si

In order to keep the area ratio of the eutectic Si in the aluminum-plating layer at 30% or less, the cooling rate after adhesion of the plating to the steel sheet in the plating bath is important. By controlling the cooling rate in a temperature range from 640 to 690 degrees C. at 10 degrees C./s or more, the eutectic Si area ratio in the plating layer cross section excluding the 1-μm-plating-topmost layer is kept at 30% or less. In aluminum plating using a plating bath mainly composed of Al and Si, solidification occurs in the order of an alloy phase, and an aluminum-plating layer including an Al—Si eutectic and an intermetallic compound, from a side close to the stainless steel sheet.

When the cooling rate of the aluminum-plating layer in the temperature range from 640 to 690 degrees C. is less than 10 degrees C./s, the eutectic Si is dispersed in the plating thickness direction, and the eutectic Si area ratio in the plating cross section excluding the 1-μm-plating-topmost layer cannot be controlled at 30% or less. When the cooling rate of the plating layer is 10 degrees C./s or more, Si is pushed to the topmost layer to be deposited therein, allowing a large amount of the eutectic Si to be within the 1-μm-topmost layer. By the control as described above, the eutectic Si area ratio in the plating cross section excluding the 1-μm-plating-topmost layer can be less than 30%. Since a region where Si is concentrated in the topmost layer is as thin as 1 μm, no significant reduction in workability occurs.

### Area Ratio of Intermetallic Compound Phase Consisting of Al—Si—Fe

In order to keep the area ratio of the intermetallic compound phase in the aluminum-plating layer at 5% or less, the plating bath composition and the cooling rate of the plating layer surface after plating are important. In addition to adjusting the plating bath composition so that the aluminum-plating layer has a composition of 1 to 10% of Fe and 3 to 18% of Si, the cooling rate in the temperature range from 640 to 690 degrees C. of the plating layer after plating is controlled in a range from 10 degrees C./s to 50 degrees C./s. When the cooling rate in the temperature range from 640 to 690 degrees C. is less than 10 degrees C./s, an excessive amount of Fe diffuses from the material of the stainless steel sheet, causing the area ratio of the intermetallic compound phase to exceed 5%. When the cooling rate in the temperature range from 640 to 690 degrees C. exceeds 50 degrees C./s, Fe can be inhibited from diffusing from the material of the stainless steel sheet and the area ratio of the intermetallic compound phase can be controlled at 5% or less, but strains are excessively introduced into the plating layer during cooling, resulting in a wavy appearance of the plated surface, which is not preferable. Thus, the upper limit of the cooling rate is preferably 50 degrees C./s.

### Thickness of Alloy Phase

Si is contained in a plating solution and the Si content in the plating bath is adjusted so that the Si content in the aluminum-plating layer is in a range from 3 to 18%, allowing for the control of the thickness of the alloy phase formed during an aluminum-plating treatment. When the Si content in the aluminum-plating layer is less than 3%, the thickness of the alloy phase grows thicker, which promotes cracking of the alloy phase during processing, hinders the flow of the plating, and generates voids between the plating and the base, thereby decreasing contact resistance. On the other hand, when the Si content in the aluminum-plating layer exceeds 18%, the thickness of the alloy phase is excessively decreased, which hinders the adhesiveness of the plating and causes the peeling of the aluminum-plating layer during processing, thereby increasing contact resistance.

The thickness of the alloy phase can also be controlled by a plating bath temperature and a plating bath immersion time, in addition to the Si content in the plating bath described above. The alloy phase is formed by Fe and/or Cr in the stainless steel sheet diffusing into the high-temperature plating bath. Thus, as the plating bath temperature is higher, a diffusion rate of the elements increases accordingly, thickening the alloy phase. Similarly, as the immersion time is longer, a diffusion distance of the elements is longer accordingly, thickening the alloy phase. In view of the above, it is preferable that the plating bath temperature is in a range from 640 to 690 degrees C. and the plating bath immersion time is in a range from 1 second to 45 seconds, in order to keep the thickness of the alloy phase at 15 μm or less.

The composition of the alloy phase is determined by the plating bath composition and the material components of the stainless steel sheet.

### EXAMPLES

The invention will be specifically described with reference to examples of the invention below. The following examples are merely exemplary and the invention is not limited thereto.

### Example 1

Molten steel having components of the base material shown in Table 1 was cast, and a cast steel thus obtained was hot-rolled and then pickled, and was further subjected to cold rolling, annealing, and electrolytic pickling to produce a cold-rolled sheet having a thickness of 1.0 mm. Thereafter, the cold-rolled sheet having a thickness of 1.0 mm was subjected to electrolytic degreasing at a temperature of 50 degrees C., with an electrolytic current density of ±0.3 A/cm², for an electrolytic time of 10 seconds. An electrolyte solution had a composition containing 20% of NaOH. An aluminum-plating layer was formed on both surfaces of the sheet by Sendzimir process. The temperature of the aluminum plating bath was 680 degrees C., the initial bath composition contained 6 to 15% of Si and the balance of Al. The Fe and Cr contents in the bath composition were adjusted throughout the plating treatment to control the Fe and Cr contents in the Al plating layer. The immersion time in the plating bath was 5 seconds. The adhesion amount of the aluminum plating was adjusted to 80 g/m² on one surface by gas wiping. The cooling rate in the temperature range from 640 to 690 degrees C. was adjusted to 30 degrees C./s using a cooling gas rate. During gas cooling, solidification nucleation by alumina particles was promoted. In this manner, the aluminum-plated stainless steel sheet used in each test example was obtained. In Table 1 and Table 2 described later, any numerical values outside the ranges defined by the invention are underlined.

TABLE 1

| | | Chemical Composition (mass %) | | | | | | | | | | | | |
|---|---|---|---|---|---|---|---|---|---|---|---|---|---|---|
| | Steel | | | | | | | | | | | | | B, V, Zr, Ga, REM, Ta, Sn, |
| | No. | C | Si | Mn | P | S | Cr | Ti | Al | N | Ni | Mo | Cu | W, Co, Sb |
| Examples | A1 | 0.018 | 0.07 | 0.10 | 0.024 | 0.0005 | 14.1 | 0.233 | 0.023 | 0.0051 | — | — | — | |
| of the | A2 | 0.009 | 0.02 | 0.08 | 0.019 | 0.0008 | 13.2 | 0.175 | 0.042 | 0.0084 | — | — | — | |
| Invention | A3 | 0.008 | 0.45 | 0.54 | 0.023 | 0.0012 | 18.5 | 0.202 | 0.044 | 0.0120 | — | — | — | |
| | A4 | 0.005 | 0.12 | 0.03 | 0.028 | 0.0045 | 17.4 | 0.097 | 0.028 | 0.0043 | — | — | — | |
| | A5 | 0.013 | 0.14 | 0.89 | 0.018 | 0.0019 | 16.2 | 0.221 | 0.016 | 0.0089 | — | — | — | |
| | A6 | 0.009 | 0.39 | 0.55 | 0.032 | 0.0068 | 17.8 | 0.231 | 0.078 | 0.0143 | — | — | — | B: 0.0007, Sb: 0.01 |
| | A7 | 0.005 | 0.25 | 0.71 | 0.018 | 0.0011 | 21.4 | 0.158 | 0.065 | 0.0113 | — | — | — | |
| | A8 | 0.007 | 0.11 | 0.34 | 0.022 | 0.0002 | 22.2 | 0.191 | 0.059 | 0.0125 | — | — | — | |
| | A9 | 0.011 | 0.09 | 0.12 | 0.022 | 0.0091 | 14.7 | 0.189 | 0.088 | 0.0076 | — | — | — | V: 0.1, Sn: 0.04 |
| | A10 | 0.015 | 0.22 | 0.23 | 0.025 | 0.0032 | 10.2 | 0.210 | 0.034 | 0.0065 | — | — | — | |
| | A11 | 0.003 | 0.08 | 0.65 | 0.027 | 0.0007 | 24.8 | 0.170 | 0.048 | 0.0138 | — | — | — | |
| | A12 | 0.003 | 0.21 | 0.33 | 0.019 | 0.0021 | 17.4 | 0.050 | 0.043 | 0.0022 | — | — | — | REM: 0.01, Zr: 0.02, W: 0.01 |
| | A13 | 0.017 | 0.24 | 0.71 | 0.021 | 0.0077 | 13.8 | 0.382 | 0.032 | 0.0211 | — | — | — | |
| | A14 | 0.017 | 0.22 | 0.08 | 0.028 | 0.0008 | 16.9 | 0.263 | 0.005 | 0.0098 | — | — | — | |
| | A15 | 0.01 | 0.05 | 0.56 | 0.019 | 0.0004 | 20.8 | 0.210 | 0.092 | 0.0111 | — | — | — | Ga: 0.003 |
| | A16 | 0.005 | 0.08 | 0.29 | 0.015 | 0.0015 | 19.8 | 0.397 | 0.058 | 0.0350 | — | — | — | |
| | A17 | 0.017 | 0.11 | 0.18 | 0.023 | 0.0047 | 22.4 | 0.288 | 0.078 | 0.0121 | 0.03 | — | — | |
| | A18 | 0.004 | 0.15 | 0.74 | 0.025 | 0.0004 | 18.1 | 0.140 | 0.089 | 0.0101 | 0.38 | — | — | |
| | A19 | 0.006 | 0.12 | 0.21 | 0.026 | 0.0055 | 22.7 | 0.182 | 0.045 | 0.0123 | — | 0.03 | — | Ta: 0.01, W: 0.01, Co: 0.1 |
| | A20 | 0.016 | 0.08 | 0.11 | 0.022 | 0.0003 | 16.5 | 0.233 | 0.088 | 0.0078 | — | 1.31 | — | |
| | A21 | 0.008 | 0.05 | 0.14 | 0.027 | 0.0010 | 17.2 | 0.144 | 0.028 | 0.0067 | 0.15 | 1.21 | 0.03 | |
| | A22 | 0.006 | 0.14 | 0.34 | 0.024 | 0.0018 | 17.3 | 0.149 | 0.043 | 0.0088 | 0.27 | 0.06 | 1.37 | |
| | A23 | 0.006 | 0.04 | 0.04 | 0.019 | 0.0009 | 17.1 | 0.230 | 0.061 | 0.0081 | 0.08 | 0.03 | 0.03 | |
| | A24 | 0.002 | 0.11 | 0.11 | 0.029 | 0.0004 | 17.7 | 0.150 | 0.088 | 0.0141 | 0.12 | 0.08 | 0.06 | |
| Comparatives | a1 | 0.023 | 0.08 | 0.12 | 0.023 | 0.0008 | 13.2 | 0.318 | 0.016 | 0.0087 | 0.04 | 0.04 | 0.04 | |
| | a2 | 0.004 | 0.14 | 1.13 | 0.033 | 0.0011 | 13.7 | 0.165 | 0.038 | 0.0121 | 0.05 | 0.05 | 0.33 | |
| | a3 | 0.007 | 0.21 | 0.87 | 0.045 | 0.0023 | 17.1 | 0.136 | 0.029 | 0.0069 | 0.04 | 1.12 | 0.22 | |
| | a4 | 0.009 | 0.09 | 0.33 | 0.011 | 0.0221 | 14.7 | 0.163 | 0.051 | 0.0074 | 0.06 | 0.54 | 0.14 | |
| | a5 | 0.005 | 0.17 | 0.21 | 0.024 | 0.0011 | 9.1 | 0.103 | 0.066 | 0.0054 | 0.07 | 0.04 | 0.04 | |
| | a6 | 0.005 | 0.32 | 0.17 | 0.028 | 0.0004 | 26.7 | 0.183 | 0.071 | 0.0129 | 0.22 | 0.31 | 0.12 | |
| | a7 | 0.003 | 0.22 | 0.11 | 0.019 | 0.0007 | 12.1 | 0.046 | 0.083 | 0.0015 | 0.35 | 0.76 | 0.11 | |
| | a8 | 0.006 | 0.15 | 0.42 | 0.018 | 0.0006 | 19.4 | 0.426 | 0.032 | 0.0371 | 0.09 | 1.24 | 0.09 | |
| | a9 | 0.007 | 0.14 | 0.15 | 0.025 | 0.0012 | 22.3 | 0.206 | 0.002 | 0.0134 | 0.04 | 1.13 | 0.08 | |
| | a10 | 0.005 | 0.19 | 0.11 | 0.023 | 0.0015 | 18.8 | 0.152 | 0.24 | 0.0099 | 0.05 | 0.89 | 0.07 | |
| | a11 | 0.006 | 0.24 | 0.18 | 0.025 | 0.0005 | 17.1 | 0.541 | 0.061 | 0.0480 | 0.07 | 1.13 | 0.05 | |

Next, properties of the aluminum-plated stainless steel sheet produced as described above were evaluated as follows.

The composition of the plating layer cross section was obtained from the EPMA concentration map analysis. The analysis of the cross section for the plating layer, alloy phase, and stainless steel sheet base was performed in a region of 5 μm in the plating thickness direction and 100 μm in the cross section longitudinal direction.

### Composition of Aluminum-plating Layer

The composition of the aluminum-plating layer was evaluated on the basis of the above EPMA concentration map analysis of the aluminum-plating layer.

Area Ratio of Intermetallic Compound Phase Consisting of Al—Si—Fe

The area ratio of the intermetallic compound phase consisting of Al—Si—Fe in the cross section of the aluminum-plating layer in the rolling direction and the sheet thickness direction was obtained from the above EPMA concentration map analysis of the aluminum-plating layer. From the obtained concentration map, an area (A) where Si is 10% or more is calculated, and in order to eliminate influence of the alloy phase where Si is concentrated, an area (B) where Fe is 1% or more, of the area (A), is calculated. An area obtained by subtracting the area (B) from the area (A) is an area (C) of the intermetallic compound phase. An area ratio of the intermetallic compound phase can be calculated by dividing the area (C) by a plating layer area.

### Eutectic Si Area Ratio in Plating Cross Section

Calculation of the eutectic Si area ratio in the cross section of the aluminum-plating layer in the rolling direction and in the sheet thickness direction excluding the 1-μm-topmost layer is described below. From the obtained EPMA concentration map referred to above of the aluminum-plating layer, an area (X) where Si is 10% or more, excluding the 1-μm-plating-topmost layer, is calculated. In order to eliminate the influence of the alloy phase where Si is concentrated, an area (Y) where Fe is 1% or more and Cr is 0.5% or more, of the area (X), is calculated. An area obtained by subtracting the area (Y) from the area (X) is a eutectic Si area (Z). The eutectic Si area ratio was calculated by dividing the area (Z) by the plating layer area.

### Alloy Phase Thickness

In the cross section in the sheet thickness direction of the aluminum-plated stainless steel sheet, a boundary between the aluminum-plating layer 1 and the alloy phase 4 was identified as a boundary where the Al concentration was 50% or more and the Fe concentration was less than 10% in the EPMA map analysis, and a boundary between the alloy phase 4 and the stainless steel sheet 5 was identified as a boundary where the Cr concentration exceeded 10% in the EPMA map analysis. The alloy phase thickness was obtained from a distance from a boundary line between the aluminum-plating layer 1 and the alloy phase 4 to a boundary line between the stainless steel sheet 5 and the alloy phase 4. In an SEM observation image, assuming that an intermediate phase of a structure having three layers with different degrees of whiteness from the surface is the alloy phase, the maximum thickness of the alloy phase may be measured in a field of view obtained at an observation magnification of 1,000 times, and the average value of the maximum thickness values measured in 10 fields of view may be defined as the alloy phase thickness.

### Non-Plated Area Ratio

A sample was sheared to have an area of 100×100 mm, and both surfaces of the sample were observed and an area of plating defects (called non-plating) was measured using an optical microscope. For the observation, the aluminum-plating layer was peeled off in the solution containing 20% of NaOH to expose a blackish alloy phase and distinguish a lustrous base, and then the non-plated portion was measured. This enables the measurement of portions coated only with the aluminum-plating layer without the alloy phase formed.

Electrical Conductivity of Aluminum-Plated Stainless Steel Sheet

The contact resistance can be measured by a four-terminal method, using a CRS-1 model manufactured by Yamazaki Seiki Kenkyusho, according to the measuring method of surface electrical contact resistance, JCBA T323:2011, published by the Japan Copper and Brass Association. The measurement was performed with a maximum load of 1 N, a sliding distance of 1 mm, and an applied current of 10 mA. The electrical conductivity was determined favorable or poor, by rating A for a resistance of 12 mΩ or less and X for a resistance exceeding 12 mΩ.

TABLE 2

| | | | Aluminum-plating Layer | | | | | | | |
|---|---|---|---|---|---|---|---|---|---|---|
| | | | | | | Intermetallic | | Alloy | Non-plated | |
| | | | Plating Layer | | | Compound | Eutectic | Phase | Portion | Property |
| | | | Composition | | | Phase Area | Si Area | Thick- | Area | Evaluation |
| | | Steel | Fe | Si | Cr | Ratio | Ratio | ness | Ratio | Electrical |
| | Code | No. | (%) | (%) | (%) | (%) | (%) | (μm) | (%) | Conductivity |
| Examples | B1 | A1 | 2 | 9 | 0.03 | 0.5 | 12.3 | 2.0 | 0.01 | A |
| of the | B2 | A2 | 4 | 12 | 0.01 | 0.5 | 15.4 | 1.7 | 0.02 | A |
| Invention | B3 | A3 | 1 | 3 | 0.03 | 0.9 | 7.7 | 4.4 | 0.03 | A |
| | B4 | A4 | 9 | 15 | 0.02 | 0.9 | 20.2 | 3.4 | 0.01 | A |
| | B5 | A5 | 10 | 18 | 0.01 | 5.0 | 30.0 | 13.6 | 0.01 | A |
| | B6 | A6 | 4 | 7 | 0.04 | 3.3 | 10.2 | 4.9 | 0.02 | A |
| | B7 | A7 | 3 | 8 | 0.03 | 1.3 | 12.7 | 6.1 | 0.01 | A |
| | B8 | A8 | 2 | 13 | 0.05 | 1.3 | 17.9 | 5.6 | 0.03 | A |
| | B9 | A9 | 8 | 17 | 0.02 | 1.3 | 22.1 | 5.2 | 0.08 | A |
| | B10 | A10 | 7 | 4 | 0.04 | 3.0 | 10.2 | 9.7 | 0.01 | A |
| | B11 | A11 | 5 | 12 | 0.03 | 3.0 | 18.5 | 9.0 | 0.01 | A |
| | B12 | A12 | 3 | 16 | 0.02 | 3.0 | 21.5 | 8.6 | 0.02 | A |
| | B13 | A13 | 3 | 11 | 0.03 | 2.3 | 16.2 | 8.4 | 0.03 | A |
| | B14 | A14 | 1 | 18 | 0.04 | 2.3 | 23.5 | 7.8 | 0.01 | A |
| | B15 | A15 | 2 | 17 | 0.04 | 2.7 | 24.2 | 9.8 | 0.01 | A |
| | B16 | A16 | 2 | 7 | 0.04 | 2.3 | 12.1 | 8.8 | 0.02 | A |
| | B17 | A17 | 10 | 3 | 0.05 | 2.1 | 9.4 | 12.1 | 0.01 | A |
| | B18 | A18 | 6 | 5 | 0.04 | 0.4 | 3.1 | 2.2 | 0.03 | A |
| | B19 | A19 | 7 | 8 | 0.02 | 5.0 | 14.6 | 14.5 | 0.04 | A |
| | B20 | A20 | 5 | 10 | 0.04 | 3.3 | 8.3 | 4.7 | 0.01 | A |
| | B21 | A21 | 5 | 12 | 0.02 | 1.7 | 15.4 | 7.6 | 0.01 | A |
| | B22 | A22 | 2 | 9 | 0.03 | 1.7 | 12.3 | 7.9 | 0.03 | A |
| | B23 | A23 | 2 | 10 | 0.02 | 1.3 | 15.4 | 2.3 | 0.02 | A |
| | B24 | A24 | 3 | 9 | 0.01 | 1.7 | 16.7 | 3.8 | 0.01 | A |
| Comparatives | b1 | a1 | 0 | 4 | 0.02 | 1.3 | 7.1 | 2.5 | 1.12 | X |
| | b2 | a2 | 5 | 10 | 0.00 | 1.3 | 15.0 | 10.4 | 1.24 | X |
| | b3 | a3 | 2 | 11 | 0.06 | 0.1 | 14.4 | 7.6 | 1.36 | X |
| | b4 | a4 | 3 | 8 | 0.02 | 1.3 | 11.2 | 2.0 | 1.22 | X |
| | b5 | a5 | 1 | 7 | 0.03 | 5.3 | 13.5 | 6.0 | 0.03 | X |
| | b6 | a6 | 2 | 3 | 0.02 | 2.8 | 6.9 | 7.8 | 1.43 | X |
| | b7 | a7 | 4 | 5 | 0.04 | 3.1 | 7.3 | 15.8 | 0.02 | X |
| | b8 | a8 | 2 | 8 | 0.05 | 4.5 | 16.7 | 12.6 | 1.31 | X |
| | b9 | a9 | 3 | 9 | 0.02 | 4.6 | 17.7 | 15.4 | 0.02 | X |
| | b10 | a10 | 3 | 10 | 0.02 | 0.8 | 14.4 | 3.7 | 1.48 | X |
| | b11 | a11 | 4 | 11 | 0.02 | 0.9 | 15.4 | 3.6 | 1.31 | X |

As shown in Table 2, for codes B1 to B24, the steel components and aluminum-plating layer composition were within the respective ranges defined by the invention, the area ratio of the intermetallic compound phase was 5% or less, the eutectic Si area ratio was 30% or less, the alloy phase thickness was 15 μm or less, and the area ratio of the non-plated portion was 1% or less. The codes B1 to B24 thus exhibited favorable electrical conductivity.

For a code b1, a C concentration in the material exceeded the upper limit to decrease corrosion resistance, which caused rust during electrolytic degreasing to make the non-plated area ratio exceed 1%. The code b1 thus had poor electrical conductivity.

For a code b2, an Mn concentration in the material exceeded the upper limit, and thus an Mn compound was concentrated in the surface of the stainless steel sheet during electrolytic degreasing to reduce the wettability of the plating with the steel sheet and to make the non-plated area ratio exceed 1%. The code b2 thus had poor electrical conductivity. In addition, the Cr concentration in the aluminum-plating layer was below the lower limit.

For codes b3 and b4, a P concentration in the material for the code b3 and an S concentration in the material for the code b4 exceeded the respective upper limits to concentrate a P compound or an S compound in the surface of the stainless steel sheet during electrolytic degreasing, and thus the wettability of the plating with the steel plate was reduced to make the non-plated area ratio exceed 1%. The codes b3 and b4 thus had poor electrical conductivity. In addition, the Cr concentration for a code b6 exceeded the upper limit.

For a code b5, the Cr concentration in the material was below the lower limit, and thus a large amount of Fe diffused from the material into the plating layer during plating bath immersion to make the area ratio of the intermetallic compound phase exceed 5%. The code b5 thus had poor electrical conductivity.

For a code b6, the Cr concentration in the material exceeded the upper limit, and thus the Fe/Cr ratio in the passivation film after electrolytic degreasing was less than 3 to make the non-plated area ratio exceed 1%. The code b6 thus had poor electrical conductivity.

For a code b7, a Ti concentration in the material was below the lower limit to make the alloy phase thickness exceed 15 μm. The code b7 thus had poor electrical conductivity.

For a code b8, the Ti concentration in the material exceeded the upper limit to concentrate a Ti compound in the surface of the stainless steel sheet during electrolytic degreasing, and thus the wettability of the plating with the steel plate was reduced to make the non-plated area ratio exceed 1%. The code b8 thus had poor electrical conductivity.

For a code b9, the Al concentration in the material was below the lower limit to make the alloy phase thickness exceed 15 μm. The code b9 thus had poor electrical conductivity.

For codes b10 and b11, the Al concentration in the material for the code b10 and an N concentration in the material for the code b11 exceeded the respective upper limits to concentrate an Al compound or an N compound in the surface of the stainless steel sheet during electrolytic degreasing, and thus the wettability of the plating with the steel sheet was reduced to make the non-plated area ratio exceed 1%. The codes b10 and b11 thus had poor electrical conductivity.

### Example 2

Steel sheets were produced using steel numbers A1, A3, A5, A7, A9, A11, A13, A14, A17, A19, A21, A23, and A24 shown in Table 1, and electrolytic degreasing and subsequent steps were performed under conditions denoted by codes C1 to C13 and c1 to c8 shown in Table 3. The production conditions other than those shown in Table 3 were the same as those in Example 1 described above. In addition to the quality evaluation conducted in Example 1, quality evaluation as below was performed. In Table 3, any numerical values outside the preferred production conditions and the ranges defined by the invention are underlined.

### Fe/Cr Ratio in Passivation Film

The Fe/Cr ratio in the passivation film for a steel sheet after electrolytic degreasing was obtained from GDS (Glow Discharge Spectroscopy). The Fe/Cr ratio was calculated using the maximum value in terms of the Fe/Cr concentration ratio. The Fe/Cr concentration ratio was constituted by the concentrations (mass %) of Fe and Cr within 20 nm from the surface that were obtained by measuring the concentration distribution of Fe and Cr from the surface to a depth of 20 nm.

### Plating Appearance

A 100 mm×100 mm sample was cut out from the steel sheet at any position, and both surfaces of the steel sheet were visually observed to count the number of plating irregularities. A case where no plating irregularities was found was evaluated as A, and a case where one or more plating irregularities was found was evaluated as X. Here, the term “plating irregularities” refers to a defect in which a wavy pattern is observed, and surface unevenness of the material is reflected.

### Overall Evaluation

When the electrical conductivity was rated as A and the plating appearance was rated as A, the overall evaluation was determined as S. When at least one of the electrical conductivity or the plating appearance was rated as X, the overall evaluation was determined as X.

TABLE 3

| | | | | | | Aluminum-plating Treatment | | | Aluminum-plating | | |
|---|---|---|---|---|---|---|---|---|---|---|---|
| | | | Electrolytic Degreasing | | | Plating Bath | | | Layer | | |
| | | | Current | Electrolysis | Fe/Cr | Immersion | Plating Bath | Cooling Rate | Plating Layer | | |
| | | Steel | Density | Time | Ratio | Time | Temperature | after Plating | Composition (%) | | |
| | Code | No. | (A/cm²) | (s) | (—) | (s) | (degrees C.) | (degrees C./s) | Fe | Si | Cr |
| Examples | C1 | A1 | 0.20 | 10.0 | 3.1 | 3.0 | 640 | 10 | 2 | 9 | 0 |
| of the | C2 | A3 | 1.20 | 15.0 | 3.5 | 3.0 | 650 | 10 | 3 | 12 | 0 |
| Invention | C3 | A5 | 0.80 | 15.0 | 3.3 | 45.0 | 690 | 10 | 2 | 8 | 0 |
| | C4 | A7 | 0.50 | 10.0 | 3.4 | 5.0 | 660 | 25 | 8 | 10 | 0 |
| | C5 | A9 | 0.30 | 100.0 | 3.2 | 5.0 | 660 | 25 | 9 | 7 | 0 |
| | C6 | A11 | 0.90 | 200.0 | 3.7 | 25.0 | 670 | 25 | 5 | 6 | 0 |
| | C7 | A13 | 1.10 | 150.0 | 3.4 | 15.0 | 670 | 35 | 3 | 9 | 0 |
| | C8 | A14 | 0.30 | 50.0 | 3.2 | 15.0 | 670 | 35 | 4 | 8 | 0 |
| | C9 | A17 | 0.20 | 300.0 | 3.5 | 1.0 | 690 | 50 | 1 | 7 | 0 |
| | C10 | A19 | 0.30 | 5.0 | 3.4 | 45.0 | 690 | 50 | 2 | 8 | 0 |
| | C11 | A21 | 0.20 | 5.0 | 3.2 | 5.0 | 670 | 50 | 4 | 9 | 0 |
| | C12 | A23 | 0.40 | 15.0 | 3.2 | 5.0 | 660 | 20 | 2 | 10 | 0 |
| | C13 | A24 | 0.50 | 15.0 | 3.3 | 5.0 | 670 | 15 | 3 | 9 | 0 |
| Comparatives | c1 | A3 | 0.05 | 5.0 | 2.2 | 3.0 | 640 | 10 | 1 | 8 | 0 |
| | c2 | A5 | 2.50 | 15.0 | 3.7 | 5.0 | 650 | 20 | 8 | 9 | 0 |
| | c3 | A7 | 0.50 | 0.5 | 1.9 | 1.0 | 650 | 25 | 2 | 10 | 0 |
| | c4 | A9 | 0.40 | 320.0 | 3.4 | 45.0 | 660 | 35 | 10 | 14 | 0 |
| | c5 | A11 | 0.30 | 20.0 | 3.4 | 0.5 | 650 | 5 | 3 | 13 | 0 |
| | c6 | A13 | 0.70 | 50.0 | 3.3 | 50.0 | 680 | 55 | 2 | 11 | 0 |
| | c7 | A14 | 1.10 | 250.0 | 3.5 | 25.0 | 620 | 20 | 4 | 10 | 0 |
| | c8 | A19 | 0.80 | 100.0 | 3.5 | 15.0 | 710 | 25 | 3 | 9 | 0 |

| | | | Aluminum-plating Layer | | | | | | |
|---|---|---|---|---|---|---|---|---|---|
| | | | Intermetallic | | | Non- | | | |
| | | | Compound | Eutectic | Alloy | plated | | | |
| | | | Phase Area | Si Area | Phase | Area | Property Evaluation | | |
| | | Steel | Ratio | Ratio | Thickness | Ratio | Electrical | Plating | Overall |
| | Code | No. | (%) | (%) | (μm) | (%) | Conductivity | Appearance | Evaluation |
| Examples | C1 | A1 | 0.5 | 12.3 | 2.0 | 0.01 | A | A | S |
| of the | C2 | A3 | 0.9 | 7.7 | 4.4 | 0.03 | A | A | A |
| Invention | C3 | A5 | 5.0 | 30.0 | 13.6 | 0.01 | A | A | S |
| | C4 | A7 | 1.3 | 12.7 | 6.1 | 0.01 | A | A | S |
| | C5 | A9 | 1.3 | 22.1 | 5.2 | 0.08 | A | A | A |
| | C6 | A11 | 3.0 | 18.5 | 9.0 | 0.01 | A | A | S |
| | C7 | A13 | 2.3 | 16.2 | 8.4 | 0.03 | A | A | A |
| | C8 | A14 | 2.3 | 23.5 | 7.8 | 0.01 | A | A | A |
| | C9 | A17 | 2.1 | 9.4 | 12.1 | 0.01 | A | A | S |
| | C10 | A19 | 5.0 | 14.6 | 14.5 | 0.04 | A | A | A |
| | C11 | A21 | 1.7 | 15.4 | 7.6 | 0.01 | A | A | S |
| | C12 | A23 | 1.3 | 15.4 | 2.3 | 0.02 | A | A | A |
| | C13 | A24 | 1.7 | 16.7 | 3.8 | 0.01 | A | A | S |
| Comparatives | c1 | A3 | 1.1 | 6.0 | 2.5 | 1.2 | X | A | X |
| | c2 | A5 | 5.7 | 22.1 | 3.2 | 0.02 | X | X | X |
| | c3 | A7 | 0.7 | 11.0 | 3.9 | 1.4 | X | A | X |
| | c4 | A9 | 5.3 | 20.8 | 7.9 | 0.03 | X | X | X |
| | c5 | A11 | 5.5 | 34.0 | 3.5 | 1.2 | X | A | X |
| | c6 | A13 | 3.3 | 15.4 | 15.3 | 0.02 | X | X | X |
| | c7 | A14 | 3.6 | 17.1 | 1.2 | 1.3 | X | A | X |
| | c8 | A19 | 1.3 | 33.0 | 16.4 | 0.03 | X | A | X |

As shown in Table 3, for the codes C1 to C13, electrolytic degreasing and subsequent steps in the production process were performed under the preferred production conditions, and the intermetallic compound phase area ratio, eutectic Si area ratio, alloy phase thickness, and non-plated area ratio satisfied the conditions defined in the invention. Therefore, the electrical conductivity and plating appearance were favorable, and thus the overall evaluation was favorable in the codes C1 to C13.

For the code c1, the aluminum-plated stainless steel sheet was produced with the current density below the lower limit, and thus the Fe/Cr ratio was less than 3 and the non-plated area ratio of 1% or less was not satisfied. The code c1 thus had poor electrical conductivity.

For the code c2, the aluminum-plated stainless steel sheet was produced with the current density exceeding the upper limit, and thus the surface of the stainless steel sheet was roughened to deteriorate the appearance of the plated surface, and deposits (pickling smut) containing Fe, which were generated on the surfaced due to excessive pickling, dissolved in the plating layer to make the area ratio of the intermetallic compound phase exceed the upper limit. The code c2 thus had poor electrical conductivity.

For the code c3, the aluminum-plated stainless steel sheet was produced in the electrolysis time below the lower limit, and thus the Fe/Cr ratio was less than 3 and the non-plated area ratio of 1% or less was not satisfied. The code c3 thus had poor electrical conductivity.

For the code c4, the aluminum-plated stainless steel sheet was produced in the electrolysis time exceeding the upper limit, and thus the surface of the stainless steel sheet was roughened to deteriorate the appearance of the plated surface, and deposits (pickling smut) containing Fe, which were generated on the surface due to excessive pickling, dissolved in the plating layer to make the area ratio of the intermetallic compound phase exceed the upper limit. The code c4 thus had poor electrical conductivity.

For the code c5, the aluminum-plated stainless steel sheet was produced with the cooling rate in the temperature range from 640 to 690 degrees C. below the lower limit, and thus the intermetallic compound phase area ratio exceeded 5% and the eutectic Si area ratio exceeded 30%. In addition, since this aluminum-plated stainless steel sheet was produced in the plating bath immersion time below the lower limit, the non-plated area ratio exceeded 1%. The code c5 thus had poor electrical conductivity.

For the code c6, the aluminum-plated stainless steel sheet was produced with the cooling rate in the temperature range from 640 to 690 degrees C. exceeding the upper limit, and thus the appearance of the plated surface was deteriorated. In addition, since this aluminum-plated stainless steel sheet was produced with the plating bath immersion time exceeding the upper limit, the alloy phase thickness exceeded 15 μm. The code c6 thus had poor electrical conductivity.

For the code c7, the aluminum-plated stainless steel sheet was produced at the plating bath temperature below the lower limit, and thus the non-plated area ratio exceeded 1%. The code 7 thus had poor electrical conductivity.

For the code 8, the aluminum-plated stainless steel sheet was produced at the plating bath temperature exceeding the upper limit, and thus the eutectic Si area ratio exceeded 30% and the alloy phase thickness exceeded 15 μm. The code 8 thus had poor electrical conductivity.

### EXPLANATION OF CODES

1 . . . aluminum-plating layer, 2 . . . eutectic Si,
3 . . . intermetallic compound phase,
4 . . . alloy phase, 5 . . . stainless steel sheet

1. An aluminum-plated stainless steel sheet, comprising:
a stainless steel sheet;
an aluminum-plating layer on a surface of the stainless steel sheet; and
an alloy phase between the stainless steel sheet and the aluminum-plating layer, wherein
the stainless steel sheet contains, by mass %, 0.02% or less of C, 0.02 to 0.50% of Si, 0.02 to 1.00% of Mn, 0.040% or less of P, 0.0002 to 0.0100% of S, 0.004 to 0.100% of Al, 10.0 to 25.0% of Cr, 0.02 to 0.40% of Ti, 0.05% or less of N, and a balance of Fe and an impurity element,
the aluminum-plating layer contains, by mass %, 1 to 10% of Fe, 3 to 18% of Si, 0.01 to 0.05% of Cr, and a balance of Al,
the aluminum-plating layer contains a eutectic Si and an intermetallic compound phase consisting of Al—Si—Fe,
an area ratio of the eutectic Si is 30% or less in a cross section in a rolling direction and in a sheet thickness direction excluding a 1-μm-topmost layer of the aluminum-plating layer,
an area ratio of the intermetallic compound phase consisting of Al—Si—Fe is 5% or less in a cross section in the rolling direction and in the sheet thickness direction of the aluminum-plating layer,
a thickness of the alloy phase is 15 m or less, and
a non-plated area ratio is 1.0% or less.

2. The aluminum-plated stainless steel sheet according to claim 1, wherein in place of a part of the Fe, the stainless steel sheet further contains, by mass %, one or more of 0.02 to 0.40% of Ni, 0.02 to 1.40% of Mo, and 0.02 to 1.40% of Cu.

3. The aluminum-plated stainless steel sheet according to claim 1, wherein in place of a part of the Fe, the stainless steel sheet further contains, by mass %, one or more of 0.0001 to 0.0020% of B, 1.00% or less of V, 0.005 to 0.50% of Zr, 0.030% or less of Ga, 0.001 to 0.10% of REM, 0.10% or less of Ta, 0.005 to 0.50% of Sn, 1.00% or less of W, 1.00% or less of Co, and 0.005 to 0.50% of Sb.

4. The aluminum-plated stainless steel sheet according to claim 2, wherein in place of a part of the Fe, the stainless steel sheet further contains, by mass %, one or more of 0.0001 to 0.0020% of B, 1.00% or less of V, 0.005 to 0.50% of Zr, 0.030% or less of Ga, 0.001 to 0.10% of REM, 0.10% or less of Ta, 0.005 to 0.50% of Sn, 1.00% or less of W, 1.00% or less of Co, and 0.005 to 0.50% of Sb.
